(19) United States
(12) Patent Application Publication
(10) Pub. No.: US 2024/0103901 A1
(43) Pub. Date: Mar. 28, 2024

(54) COMMUNICATION CONTROL DEVICE, COMMUNICATION CONTROL PROGRAM AND ELECTRONIC CONTROL UNIT

(71) Applicant: DENSO CORPORATION, Kariya-city (JP)

(72) Inventors: Satoki TAKAHASHI, Kariya-city (JP); Manabu OHI, Minato-ku, Tokyo (JP)

(21) Appl. No.: 18/473,340

(22) Filed: Sep. 25, 2023

(30) Foreign Application Priority Data
Sep. 27, 2022 (JP) 2022-153749

(51) Int. Cl. G06F 9/455

(52) U.S. Cl. CPC G06F 9/45558; G06F 2009/45595

(57) ABSTRACT

A communication control device controls communication by a plurality of virtual machines operating on a computer. The plurality of virtual machines includes a master virtual machine and at least one slave virtual machine other than the master virtual machine. The communication control device is configured to access a communication device for communicating with an external device, and transmit and receive communication data that relates to the communication between the master virtual machine and the external device, transmit and receive the communication data between each of the plurality of virtual machines, and relay communication between each of the plurality of virtual machines and the external device.

### CROSS REFERENCE TO RELATED APPLICATION

This application is based on Japanese Patent Application No. 2022-153749 filed on Sep. 27, 2022, the disclosure of which is incorporated herein by reference.

### TECHNICAL FIELD

The present disclosure relates to a communication control device for controlling communication by multiple virtual machines operating on a computer, a communication control program executed by the communication control device, and an electronic control unit provided with the communication control device.

### BACKGROUND

A related art discloses a communication method in an integrated ECU. According to a method described in a related art, when a CAN transmission request arrives from a virtual machine, arbitration is performed within a virtual device that serves as an interface between the virtual machine and a peripheral device of a CPU in the integrated ECU to access the CAN controller.

### SUMMARY

The present disclosure provides a communication control device that controls communication by a plurality of virtual machines operating on a computer, the plurality of virtual machines including a master virtual machine and at least one slave virtual machine other than the master virtual machine, the communication control device configured to: access a communication device for communicating with an external device, and transmit and receive communication data that relates to the communication between the master virtual machine and the external device; transmit and receive the communication data between each of the plurality of virtual machines; and relay communication between each of the plurality of virtual machines and the external device.

### BRIEF DESCRIPTION OF DRAWINGS

Objects, features and advantages of the present disclosure will become more apparent from the following detailed description made with reference to the accompanying drawings. In the drawings:

FIG. 1 is a diagram schematically showing a configuration related to communication between an integrated ECU and an external device according to one embodiment;

FIG. 2 is a diagram schematically showing an example of the structure of an interrupt factor flag register according to one embodiment;

FIG. 3 is a diagram schematically showing an example of the configuration of a virtual CAN driver and a CAN _ID filter definition table according to one embodiment;

FIG. 4 is a diagram explaining an example of a specific operation by a relay software according to an embodiment;

FIG. 5 is a diagram schematically showing the contents of relay processing executed by the relay software according to one embodiment;

FIG. 6 is a diagram explaining an example of a reception interrupt control according to one embodiment; and

FIG. 7 is a diagram schematically showing a comparative example showing a configuration related to communication of multiple ECUs that are not integrated as an integrated ECU.

### DETAILED DESCRIPTION

For example, a vehicle such as an automobile is equipped with multiple electronic control units. The multiple electronic control units communicate with each other to perform various processes in cooperation with each other. Incidentally, in this description, an electronic control unit may be referred to as an ECU. Further, an electronic control unit may be referred to an electronic control device. In recent years, as the number of ECUs mounted on vehicles tends to increase. The multiple ECUs may be integrated into a single ECU. The single ECU may be referred to as an integrated ECU.

In the integrated ECU, which is an ECU integrated, various functions that are performed by multiple ECUs, which conventionally operated independently, are installed as virtual machines. A related art discloses a communication method in an integrated ECU. According to a method described in a related art, when a CAN transmission request arrives from a virtual machine, arbitration is performed within a virtual device that serves as an interface between the virtual machine and a peripheral device of a CPU in the integrated ECU to access the CAN controller. Here, CAN is a registered trademark and is an abbreviation for Controller Area Network.

In a technology disclosed in a related art, it is not considered to perform CAN communication between virtual machines. A communication similar to communication performed between multiple ECUs before the integration may not be executed. In addition, in the technology disclosed in a related art, since the transmission request from a virtual machine is arbitrated within the virtual device, overhead of the CAN data transmission time may be required due to the arbitration process.

The present disclosure provides a communication control device capable of communicating between multiple virtual machines while eliminating the access arbitration processing between the virtual machines, a communication control program, and an electronic control unit.

According to one aspect of the present disclosure, a communication control device that controls communication by a plurality of virtual machines operating on a computer may be provided. The plurality of virtual machines includes a master virtual machine and at least one slave virtual machine other than the master virtual machine. The communication control device may comprise: a physical communication driver that is provided in the master virtual machine and is configured to access a communication device communicating with an external device provided outside the computer and transmit and receive communication data relating to the communication between the master virtual machine and the external device; a virtual communication driver that is provided in each of the plurality of virtual machines and is configured to transmit and receive the communication data between each of the plurality of virtual machines; and a relay unit that is provided in the master virtual machine and is configured to relay communication between each of the plurality of virtual machines and the external device.

The computer includes a shared memory shared by each of the plurality of virtual machines. The virtual communication driver virtually transmits and receives the communication data via the shared memory. In a case where the relay unit receives the communication data transmitted from the slave virtual machine, the relay unit executes a reception process in which the communication data is received according to the destination of the communication data or a transmission process in which the communication data is transmitted to the external device via the physical communication driver.

According to this configuration, the multiple virtual machines (VMs) include a master VM that directly accesses the communication device and communicates with the external device, and a slave VM that communicates with the external device via the master VM without directly accessing the communication device. In this case, only the master VM among the multiple virtual machines accesses the communication device. In other words, in this configuration, the virtual machine that accesses the communication device is limited to the master VM. Thus, according to this configuration, by limiting a virtual machine that access the communication device, it may be possible to eliminate the processing of access arbitration to the communication device between virtual machines.

In this configuration, a virtual communication is performed between the master VM and the slave VMs and between the slave VMs via a shared memory. It may be possible to execute communication between them. Therefore, according to this configuration, it may be possible that communication is performed between each of the multiple virtual machines while eliminating the need for access arbitration processing between the virtual machines.

Embodiments of a communication control device, a communication control program, and an electronic control unit will be described below with reference to the drawings.

### (Structure of Multiple Conventional ECUs)

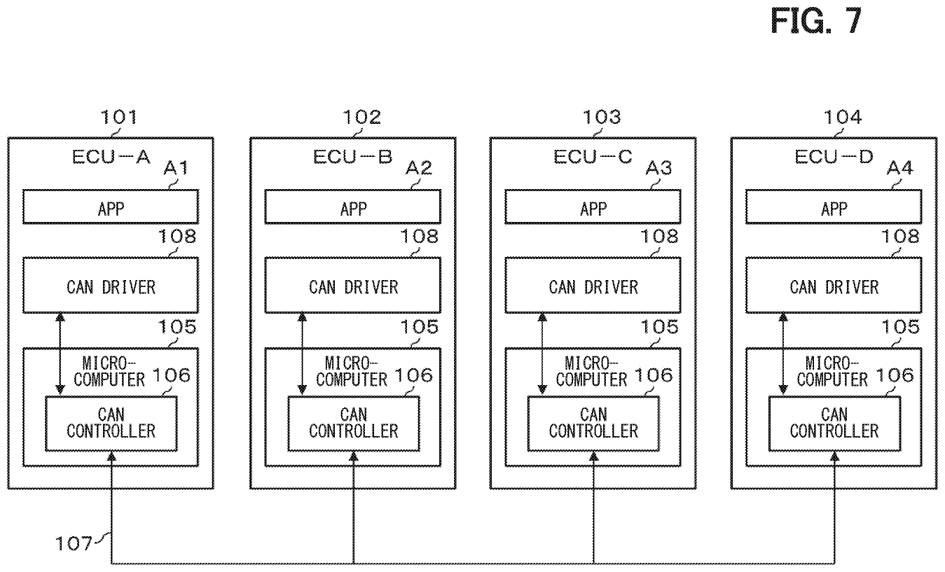

A configuration related to communication of multiple ECUs before being integrated as an integrated ECU will be described with reference to FIG. 7. In a configuration shown in FIG. 7, the multiple ECUs are mounted on a vehicle, such as an ECU-A 101, an ECU-B 102, an ECU-C 103, and an ECU-D 104, which are four ECUs. The number of the multiple ECUs mounted on the vehicle may be two or three ECUs, or even five or more ECUs.

The ECU-A 101, the ECU-B 102, the ECU-C 103 and the ECU-D 104 are, for example, an engine ECU, an air conditioner ECU, a central gateway ECU and a body ECU, and are provided independently. Each of the ECU-A 101, the ECU-B 102, the ECU-C 103 and the ECU-D 104 has a microcomputer 105. A microcomputer may be referred to as a computer, a processor, or the like.

The microcomputer 105 has a CPU and various peripherals (not shown) as its hardware. The various peripherals include a CAN controller 106 performing CAN communication, for example. The ECU-A 101, the ECU-B 102, the ECU-C 103, and the ECU-D 104 are connected via a CAN bus 107, which is a bus communication line, thereby enabling CAN communication between them.

The ECU-A 101 has an ECU-A application Al for implementing its main functions. An application may be abbreviated as APP. The ECU-B 102 has an ECU-B application A2 for implementing its main functions. The ECU-C 103 has an ECU-C application A3 for implementing its main functions. The ECU-D 104 has an ECU-D application A4 for implementing its main functions. In the explanation, the ECU-A application A1, the ECU-B application A2, the ECU-C application A3, and the ECU-D application A4 are respectively referred to as application Al, application A2, application A3, and application A4.

Each of the ECU-A 101, the ECU-B 102, the ECU-C 103 and the ECU-D 104 has a CAN driver 108. The CAN driver 108 controls the CAN controller 106 to perform data communication with other ECUs via the CAN bus 107. The application A1, the application A2, the application A3, the application A4, and the CAN driver 108 each is implemented by executing a computer program stored in a non-transitory tangible storage medium by the CPU of the microcomputer 105, which performs processing corresponding to the computer program. That is, the application Al, the application A2, the application A3, the application A4, and the CAN driver 108 each is implemented by software.

In this configuration, when one of the ECUs performs CAN communication, the CAN driver 108 provided in the corresponding ECU controls the CAN controller 106 to perform data communication. Multiple ECUs, that is, the ECU-A 101, the ECU-B 102, the ECU-C 103 and the ECU-D 104 are connected as nodes on the CAN bus 107. CAN data, which is communication data transmitted on the CAN bus 107 by any of the ECUs, can be received by all ECUs connected to the CAN bus 107.

(Configuration of Integrated ECU of the Present Embodiment)

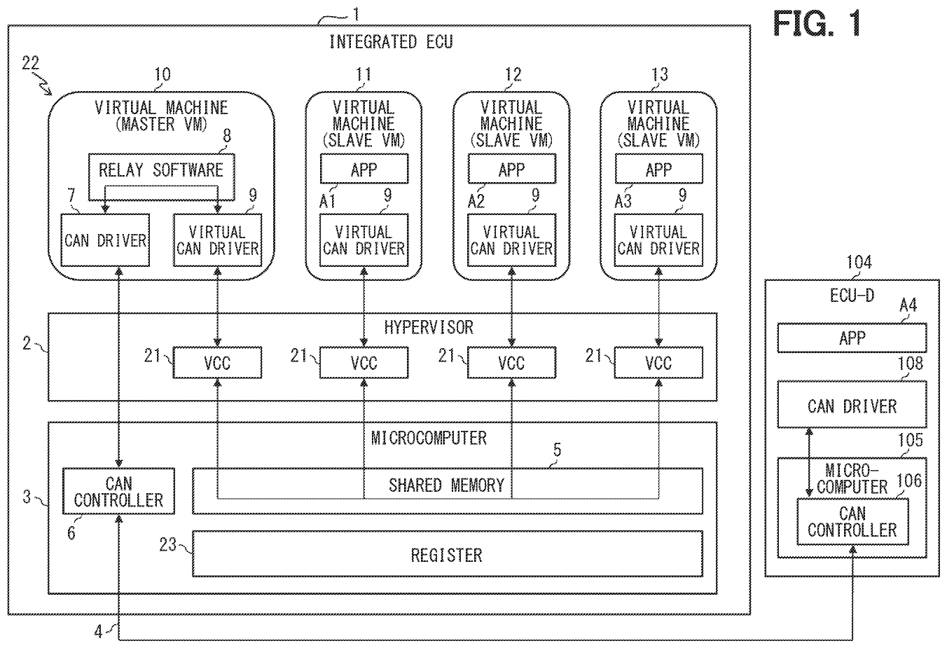

As shown in FIG. 1, an integrated ECU 1 of the present embodiment is mounted in a vehicle such as an automobile. In the integrated ECU 1, the functions of multiple ECUs that operated independently are mounted on a chip of a single microcomputer 3 through the hypervisor 2. In this case, functions of multiple ECUs are installed in units of virtual machines. In this specification, a hypervisor may be abbreviated as HV. A virtual machine may be abbreviated as VM.

The integrated ECU 1 has functions corresponding to the three ECUs, the ECU-A 101, the ECU-B 102 and the ECU-C 103 in the above-described configuration, for example. The integrated ECU 1 may have functions corresponding to two ECUs or may have functions corresponding to four or more ECUs. In this embodiment, the ECU-D 104 is provided independently and is not integrated as the integrated ECU 1. The integrated ECU 1 and the ECU-D 104 are connected via a CAN bus 4, which is a bus communication line, so that CAN communication can be performed between them.

The integrated ECU 1 is provided with four a VM 10, a VM 11, a VM 12 and a VM 13. In this case, the function as the ECU-A 101 is implemented by the VM 11, the function as the ECU-B 102 is implemented by the VM 12, and the function as the ECU-C 103 is implemented by the VM 13. That is, in this case, the VM 11 has the application A1, the VM 12 has the application A2, and the VM 13 has the application A3. The VM 10 has the function of a gateway ECU. The VM 10 may have the function of another ECU instead of or in addition to this.

The HV 2 is provided in order to operate the VM 10 to the VM 13 on the microcomputer 3. The microcomputer 3 is an example of a computer, and includes a CPU (not shown), various peripherals, and a shared memory 5 shared by each of the VM 10 to the VM 13 as hardware. The various peripherals include a CAN controller 6 for performing CAN communication. The CAN controller 6 performs CAN communication with an external device provided outside the microcomputer 3 and is an example of a communication device. In this embodiment, the ECU-D 104 corresponds to the external device described above. Although not shown, the external devices include all ECUs connected to the CAN bus 4 other than the integrated ECU 1.

In this embodiment, one of the four VMs 10 to 13 included in the integrated ECU 1, which is the VM 10, is designated as a master VM. The VMs other than the VM 10, which are the VM 11 to the VM 13, are designated as slave VMs. Therefore, in the following description, the VM 10 may be referred to as a master VM. The VM 11 to VM 13 may be referred to as slave VMs.

The VM 10 includes a CAN driver 7 and a relay software 8. The CAN driver 7 has the corresponding function as the CAN driver 108. That is, the CAN driver 7 accesses the CAN controller 6 to transmit and receive CAN data, which is data related to CAN communication, between the VM 10 and the ECU-D 104 and is an example of a physical communication driver. In this embodiment, CAN communication is an example of communication. CAN data is an example of communication data. The relay software 8 relays CAN communication between each of the VM 10 to the VM 13 and the ECU-D 104 and is an example of a relay unit.

Each of the VM 10 to the VM 13 has a virtual CAN driver 9. The virtual CAN driver 9 transmits and receives CAN data between each of the VM 10 to the VM 13 and is an example of a virtual communication driver. The virtual CAN driver 9 uses the shared memory 5 to virtually transmit and receive CAN data. In this case, the virtual CAN driver 9 is mounted on the virtual communication channel module 21 that accesses the shared memory 5 to transmit and receive CAN data. In this specification, a virtual communication channel module may be abbreviated as VCC.

In this case, the VCC 21 is included in the HV 2, and is provided corresponding to each of the VM 10 to the VM 13. That is, each virtual CAN driver 9 mounted on the VM 10 to the VM 13 is connected to the corresponding VCC 21. According to this configuration, the CAN data transmitted by the application Al of the VM 11 can be transmitted to the application A2 of the VM 12, the application A3 of the VM 13, and the like. That is, according to this configuration, it may be possible to implement a virtual CAN bus that allows CAN communication between the VMs 10 to 13 respectively. In other words, it may be possible to implement a virtual communication bus.

Thus, in this configuration, a communication control device 22 is composed of the CAN driver 7 provided in the master VM, the virtual CAN driver 9 provided in each of the multiple VMs 10 to 13, the relay software 8 provided in the master VM, and the VCC 21 provided in the HV 2 and the like so as to control CAN communication by the multiple VMs 10 to 13 operating on the microcomputer 3. In this case, the integrated ECU 1 is an example of an electronic control unit including a microcomputer 3, the VM 10 to the VM 13 operating on the microcomputer 3, and a communication control device 22.

In the integrated ECU 1 configured as described above, each of the HV 2 and the VM 10 to the VM 13 is implemented by software. Each of the HV 2 and the VM 10 to the VM 13 each is implemented by executing a computer program stored in a non-transitory tangible storage medium by the CPU of the microcomputer 3, which performs processing corresponding to the computer program. The program to implement the function of the communication control device 22, that is, the program to be executed by the communication control device 22, corresponds to the communication control program.

The microcomputer 3 has a flag register. More specifically, the microcomputer 3 has an interrupt factor flag register 23. The interrupt factor flag register 23 is an example of a register that stores an interrupt factor flag which is a flag indicating whether or not a reception interrupt of CAN data has occurred for each of the VM 10 to the VM 13. In the following description, the interrupt factor flag register may be simply referred to as a register.

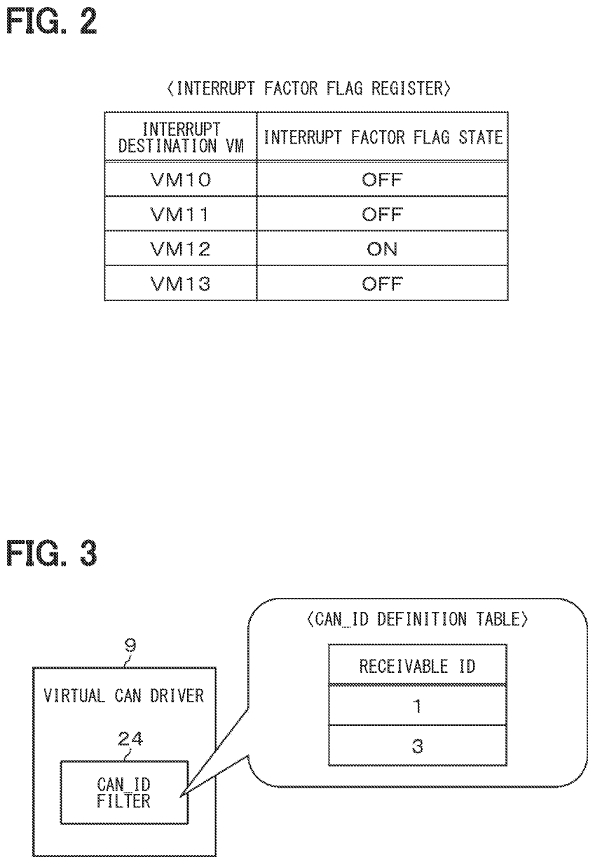

The register 23 has a structure as shown in FIG. 2, for example. In the register 23, an interrupt factor flag state is set for each of the VM 10 to the VM 13, which is an interrupt destination VM. The interrupt factor flag state represents the state of the interrupt factor flag. The interrupt factor flag state is one of two states: “ON”, indicating that a reception interrupt of a CAN data has occurred, or “OFF”, indicating that a reception interrupt of a CAN data has not occurred. Details will be described later, in this configuration, CAN data is transmitted and received between the VM 10 to the VM 13 by performing a reception interrupt control using the interrupt factor flag stored in the register 23.

In a configuration that performs physical CAN communication, that is, a configuration that performs physical CAN, such as the configuration shown in FIG. 7, in general, there is a mechanism whereby CAN_ID filtering is performed by the CAN controller 106 provided by each ECU, so that CAN data not addressed to its own device is discarded and only CAN data addressed to its own device is received. By contrast, in the configuration in which virtual CAN communication is performed as in the present embodiment, the VM 10 to the VM 13 having the corresponding functions as the conventional ECUs do not have a CAN controller.

In the configuration of the present embodiment, the virtual CAN driver 9 is provided with a CAN_ID filtering function in each of the VM 10 to the VM 13. That is, in this case, as shown in FIG. 3, the virtual CAN driver 9 included in each of the VM 10 to the VM 13 includes a CAN_ID filter 24. The CAN_ID filter 24 is an example of a filter that allows CAN data addressed to a predetermined VM out of the received CAN data to pass and that discards other CAN data. The CAN_ID filter 24 may be implemented by software. In this description, the CAN_ID filter may simply be referred to as a filter.

In this embodiment, each of the VM 10 to the VM 13 is given each CAN_ID, which is identification information representing a destination in each CAN communication. In this case, “CAN_ID=0” is assigned to the VM 10, “CAN_ID=1” is assigned to the VM 11, “CAN_ID=2” is assigned to the VM 12, and “CAN_ID=3” is assigned to the VM 13. Also, in this case, the CAN data is given a CAN_ID to indicate its destination.

Basically, the slave VM only needs to be able to receive CAN data addressed to itself. Therefore, the filter 24 provided in the virtual CAN driver 9 of the slave VM passes at least CAN data addressed to its own device, that is, CAN data whose destination is the CAN_ID of the VM in which itself is provided and discards other CAN data.

By contrast, for the master VM, in addition to receiving CAN data addressed to its own device, the master VM needs to receive basically all CAN data since the master VM may relay CAN data to an external device such as the ECU-D 104. The filter 24 provided in the virtual CAN driver 9 of the master VM passes at least the CAN data addressed to its own device and the CAN data addressed to all slave VMs, that is, the CAN data whose destination is CAN_ID of one of the VM 11 to the VM 13 and discards the other CAN data.

The filter 24 has a CAN_ID filter definition table that defines CAN_IDs that can be passed through, that is, receivable. The CAN_ID filter definition table has contents as shown in FIG. 3, for example. As shown in FIG. 3, in the CAN_ID filter definition table, the CAN data with “CAN_ID=1”, that is, CAN data addressed to the VM 11, and the CAN data with “CAN_ID=3”, that is, CAN data addressed to the VM 13, are defined as receivable IDs.

The filter 24 has the CAN_ID filter definition table. It is determined that the CAN data is passed or discarded according to the definition of the table. For example, the filter 24 with the CAN_ID filter definition table as shown in FIG. 3 passes the CAN data with “CAN_ID=1,” that is, the CAN data addressed to the VM 11. The filter 24 discards the CAN data with “CAN_ID=2”, that is, the CAN data addressed to the VM 12.

Next, an operation regarding communication in the integrated ECU 1 having the above configuration will be described.

### (Specific Example of Operation by a Relay Software)

When the relay software 8 receives the CAN data transmitted from the slave VM, the relay software 8 performs a reception process to receive the CAN data according to the destination of the CAN data or performs a transmission process to transmit the CAN data to the ECU-D 104, which is an external device, via the CAN driver 7. The destination of the CAN data is one of all ECUs connected on each VM and CAN bus 4 other than the integrated ECU 1.

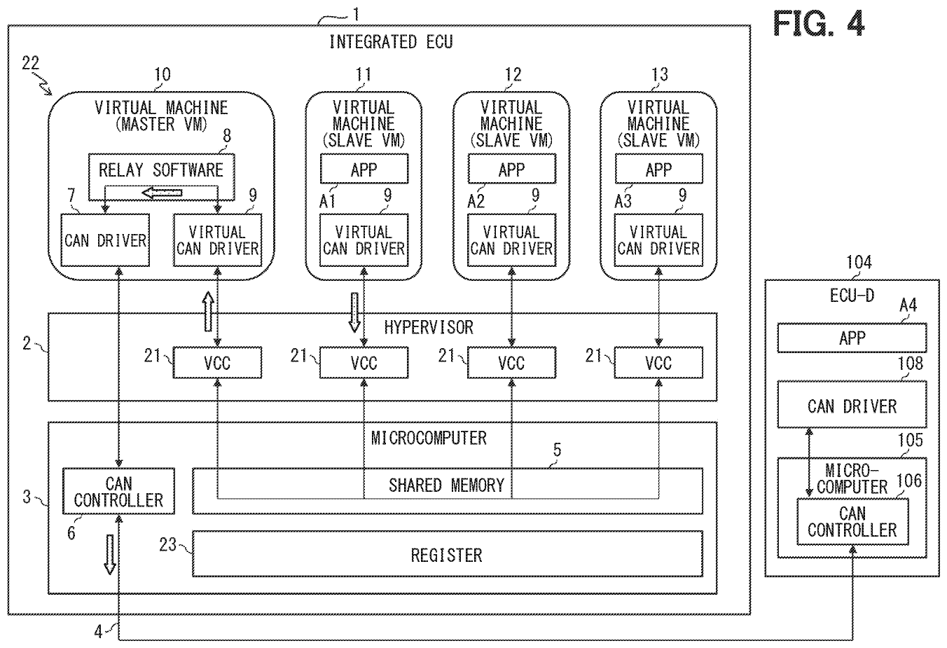

For example, when the CAN data is transmitted from the VM 11, the CAN data is sequentially transmitted in the flow indicated by the shaded arrows in FIG. 4. That is, the virtual CAN driver 9 of the VM 11 transmits the CAN data through the VCC 21 and the shared memory 5, that is, transmits the CAN data through a virtual CAN communication. Upon receiving the CAN data transmitted from the VM 11 via the VCC 21 and the shared memory 5, the virtual CAN driver 9 of the VM 10 transmits the received CAN data to the relay software 8.

The relay software 8 executes the reception processing when the destination of the received CAN data is addressed to the master VM, and executes the transmission processing when the destination is addressed to the external device such as the ECU-D 104. In the transmission processing, the CAN driver 7 of the VM 10 controls the CAN controller 6 to transmit the CAN data transmitted by the virtual CAN communication from the VM 11 via the CAN bus 4, that is, the physical CAN communication.

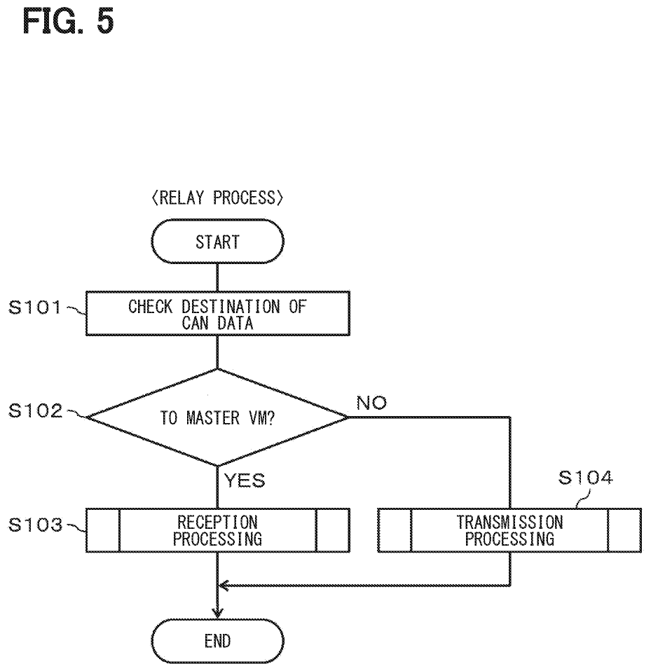

Each time the relay software 8 receives the CAN data, the relay processing as shown in FIG. 5 is executed. In S101, the destination of the received CAN data is checked. After the execution of S101, the process proceeds to S102. It is determined whether or not the destination of the CAN data is addressed to the master VM. Here, when the destination of the CAN data is the master VM, the result is “YES” in S102, and the process proceeds to S103. In S103, the reception processing described above is executed.

By contrast, when the destination of the CAN data is not addressed to the master VM, that is, when the destination of the CAN data is addressed to an external device such as the ECU-D 104, the result is “NO” in S102, and the process proceeds to S104. In S104, the transmission processing described above is executed. After the execution of S103 or S104, the relay processing executed by the relay software 8 terminates.

### (Reception Interrupt Control)

The reception interrupt control is implemented when the CAN data is transmitted and received between the VM 10 to the VM 13. The detail is described below. First, the virtual CAN driver 9 of a transmission machine, which is a VM transmitting CAN data among the VM 10 to the VM 13, writes the CAN data to the shared memory 5. Also, the virtual CAN driver 9 of the transmission machine updates the interrupt factor flag corresponding to the reception machine, which is the VM receiving the CAN data among the VM 10 to the VM 13, from “OFF” to “ON”. And then, when the interrupt factor flag corresponding to the reception machine is updated from “OFF” to “ON”, the virtual CAN driver 9 of the reception machine reads and receives the CAN data written in the shared memory 5.

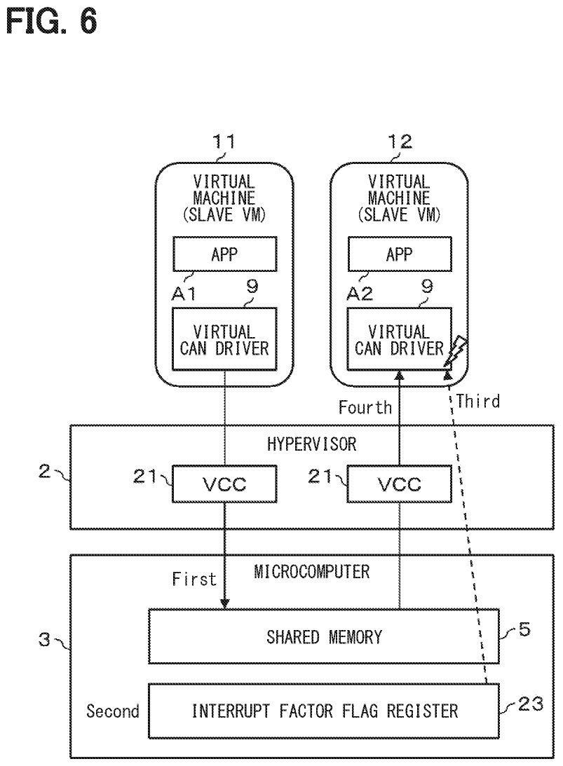

An example will be explained with reference to FIG. 6. When the CAN data is transmitted from the VM 11 to the VM 12, the reception interrupt control is performed to generate a reception interrupt. As shown with a mark (1) in FIG. 6, the virtual CAN driver 9 of the VM 11 writes the CAN data to be transmitted into the shared memory 5. Subsequently, as shown with a mark (2) in FIG. 6, the virtual CAN driver 9 of the VM 11 updates the interrupt factor flag corresponding to the VM 12 in the register 23 from “OFF” to “ON.”

When the interrupt factor flag is updated, the microcomputer 3 performs an interrupt to the VM 12, as shown with the mark (3) in FIG. 6. At this time, the interrupt factor flag corresponding to the VM 12 is returned from “ON” to “OFF” by hardware processing. Then, as indicated by the mark (4) in FIG. 6, the virtual CAN driver 9 of the VM 12 performs reception processing for reading and receiving the CAN data written in the shared memory 5 within the interrupt context.

According to the present embodiment described, the following effects can be obtained. The multiple VMs included in the integrated ECU 1 of the present embodiment include a VM 10 that is a master VM which directly accesses the CAN controller 6 and communicates with an external device, and VM 11 to VM 13 that are slave VMs which do not directly access the CAN controller 6 and communicate with an external device via the master VM.

That is, in this case, only the VM 10, which is the master VM, among the four VM 10 to VM 13 accesses the CAN controller 6. In other words, in the above configuration, the VM that accesses the CAN controller 6 is limited to the master VM. In this way, according to this configuration, by limiting the VMs that access the CAN controller 6, it may be possible to eliminate the processing of access arbitration to the CAN controller 6 between the VMs.

In this above configuration, virtual communication is performed between the master VM and each of the slave VMs and between the slave VMs via the shared memory 5 of the microcomputer 3. It may be possible to perform communication between each of the multiple VMs. Therefore, according to the configuration of the present embodiment, it may be possible to perform communication between each of the multiple VMs while eliminating the processing of access arbitration between the VMs.

In this embodiment, each of the VM 10 to the VM 13 are equipped with a virtual CAN driver 9 that uses the shared memory 5 of the microcomputer 3 to virtually transmit and receive CAN data. According to this configuration, it may be possible to replace physical CAN communication performed between ECUs for virtual CAN communication via the shared memory 5. The physical CAN communication corresponds to a CAN communication before integration of ECUs.

In this embodiment, the relay software 8 included in the master VM relays the CAN communication between each of the VM 10 to the VM 13 and the external device when receiving CAN data, without arbitration. Therefore, according to the present embodiment, almost no waiting time occurs in CAN communication between each of the VM 10 to the VM 13 and the external device. It may be possible to immediately execute the CAN communication between each of the VM 10 to the VM 13 and the external device.

The software constituting the integrated ECU 1 of the present embodiment can be the content of the software constituting the ECU before the integration shown in FIG. 7 with modification only in the part related to CAN communication. Therefore, according to the present embodiment, it may be possible to localize the parts of software changes when integrating ECUs that have conventionally operated independently, thereby reducing the man-hours required for software changes.

In this embodiment, the virtual CAN driver 9 included in the VM 10 to the VM 13 is mounted on the VCC 21 that accesses the shared memory 5 of the microcomputer 3 and transmits and receives the CAN data, which is communication data. In this way, the VCC 21, which is the part that communicates between the VMs, and the communication protocol part are separated. Accordingly, even when a protocol other than CAN is applied as a communication protocol, it may be possible to localize the changes in the software described above.

In this embodiment, the virtual CAN driver 9 provided in the VM 10 to the VM 13 is provided with the filter 24 by software that passes the CAN data addressed to a predetermined VM among the received CAN data and discards the other CAN data. That is, in this embodiment, the virtual CAN driver 9 performs processing corresponding to hardware filtering, which is performed in a conventional configuration for performing physical CAN. According to this configuration, it may be possible to reduce the CAN data to be processed in the applications A1, A2, A3 or the like.

(Other Embodiments)

The present disclosure is not limited to the embodiments that have been described above and illustrated in the drawings, but can arbitrarily be modified, combined, or expanded without departing from the gist of the present disclosure. The numerical values and the like shown in the above embodiments are examples and are not limited thereto.

The present disclosure is not limited to the application of controlling CAN communication by multiple VMs running on a microcomputer 3 that constitutes an integrated ECU 1 mounted on a vehicle but may be applied to the general application of controlling communication by multiple VMs running on a computer.

Although the disclosure has been described in accordance with the examples, it is understood that the present disclosure is not limited to the above examples or structures. The present disclosure incorporates various modifications and variations within the scope of equivalents. In addition, while the various elements are shown in various combinations and configurations, which are exemplary, other combinations and configurations, including more, less or only a single element, are also within the spirit and scope of the present disclosure.

The controller and the method thereof described in the present disclosure are implemented by a dedicated computer provided by configuring a processor and a memory programmed to execute one or more functions embodied by a computer program. Alternatively, the control circuit described in the present disclosure and the method thereof may be realized by a dedicated computer configured as a processor with one or more dedicated hardware logic circuits. Alternatively, the controller and the method described in the present disclosure may be implemented by one or more special purpose computer, which is configured as a combination of a processor and a memory, which are programmed to perform one or more functions, and a processor which is configured with one or more hardware logic circuits. The computer program may be stored in a computer-readable non-transitory tangible recording medium as an instruction to be executed by the computer.

The present disclosure can be realized in various forms such as a program. The program may be stored in a computer-readable, non-transitory tangible storage medium as instructions to be executed by a computer. For example, the program may be stored in a flash memory, ROM, or the like.

The controllers and methods described in the present disclosure may be implemented by a special purpose computer created by configuring a memory and a processor programmed to execute one or more particular functions embodied in computer programs. Alternatively, the controllers and methods described in the present disclosure may be implemented by a special purpose computer created by configuring a processor provided by one or more special purpose hardware logic circuits. Alternatively, the controllers and methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

Here, the process of the flowchart or the flowchart described in this application includes a plurality of sections (or steps), and each section is expressed as, for example, S101. Further, each section may be divided into several subsections, while several sections may be combined into one section. Furthermore, each section thus configured may be referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A communication control device that controls communication by a plurality of virtual machines operating on a computer, the plurality of virtual machines including a master virtual machine and at least one slave virtual machine other than the master virtual machine, the communication control device comprising:
a physical communication driver that is provided in the master virtual machine and is configured to access a communication device communicating with an external device provided outside the computer and transmit and receive communication data relating to the communication between the master virtual machine and the external device;
a virtual communication driver that is provided in each of the plurality of virtual machines and is configured to transmit and receive the communication data between each of the plurality of virtual machines; and
a relay unit that is provided in the master virtual machine and is configured to relay communication between each of the plurality of virtual machines and the external device,
wherein:
the computer includes a shared memory shared by each of the plurality of virtual machines;
the virtual communication driver virtually transmits and receives the communication data via the shared memory; and
in a case where the relay unit receives the communication data transmitted from the slave virtual machine, the relay unit executes a reception process in which the communication data is received according to the destination of the communication data or a transmission process in which the communication data is transmitted to the external device via the physical communication driver.

2. The communication control device according to claim 1, further comprising:
a virtual communication channel module that is configured to transmit and receive the communication data by accessing the shared memory,
wherein:
the virtual communication driver is mounted on the virtual communication channel module.

3. The communication control device according to claim 1, wherein:
the computer includes a register that is configured to store a flag indicating whether or not a reception interrupt of the communication data has occurred for each of the plurality of virtual machines; and
in a case where the communication data is transmitted and received between the plurality of virtual machines,
the virtual communication driver of a transmission machine, which is a virtual machine transmitting the communication data among the plurality of virtual machines, writes the communication data to the shared memory and updates the flag corresponding to a reception machine, which is a virtual machine receiving the communication data among the plurality of virtual machines, to a state indicating that the reception interrupt has occurred, and
the virtual communication driver of the reception machine reads and receives the communication data written in the shared memory in a case where the flag corresponding to the reception machine is updated to a state indicating that the reception interrupt has occurred.

4. The communication control device according to claim 1, wherein:
the virtual communication driver includes a filter that passes the communication data addressed to a predetermined virtual machine among the received communication data and discards other communication data; and
the filter is implemented by software.

5. The communication control device according to claim 4, wherein:
the filter included in the virtual communication driver of the master virtual machine passes the communication data addressed to all the slave virtual machines.

6. A non-transitory computer readable storage medium storing a communication control program executable by a communication control device controlling communication by a plurality of virtual machines operating on a computer, the plurality of virtual machines including a master virtual machine and at least one slave virtual machine other than the master virtual machine, the communication control device including a physical communication driver that is provided in the master virtual machine and is configured to access a communication device communicating with an external device provided outside the computer and transmit and receive communication data relating to the communication between the master virtual machine and the external device, the computer including a shared memory shared by each of the plurality of virtual machines, the program comprising instructions configured to:
transmit and receive the communication data between each of the plurality of virtual machines for each of the plurality of virtual machines, as a virtual communication driver; and
relay communication between each of the plurality of virtual machines and the external device to the master virtual machine, as a relay unit,
wherein:
the virtual communication driver virtually transmits and receives the communication data via the shared memory; and
in a case where the relay unit receives the communication data transmitted from the slave virtual machine, the relay unit executes a reception process in which the communication data is received according to the destination of the communication data or a transmission process in which the communication data is transmitted to the external device via the physical communication driver.

7. An electronic control unit comprising:
a computer;
a plurality of virtual machines operating on the computer; and
a communication control device controlling communication by the plurality of virtual machines,
wherein:
the plurality of virtual machines including a master virtual machine and at least one slave virtual machine other than the master virtual machine;
the communication control device includes
a physical communication driver that is configured to be provided in the master virtual machine, access a communication device for communicating with an external device provided outside the computer, and transmit and receive communication data that relates to the communication between the master virtual machine and the external device,
a virtual communication driver that is configured to be provided in each of the plurality of virtual machines, and transmit and receive the communication data between each of the plurality of virtual machines, and
a relay unit that is configured to be provided in the master virtual machine and relay communication between each of the plurality of virtual machines and the external device;
the computer includes a shared memory shared by each of the plurality of virtual machines;
the virtual communication driver virtually transmits and receives the communication data via the shared memory; and
in a case where the relay unit receives the communication data transmitted from the slave virtual machine, the relay unit executes a reception process in which the communication data is received according to the destination of the communication data or a transmission process in which the communication data is transmitted to the external device via the physical communication driver.
